(19) United States
(12) Patent Application Publication
(10) Pub. No.: US 2013/0178251 A1
(43) Pub. Date: Jul. 11, 2013

(54) Headset with Switch Function

(71) Applicant: Kenneth Pan, Taipei City (TW)

(72) Inventor: Kenneth Pan, Taipei City (TW)

(73) Assignee: VTECH TECHNOLOGY CORP.

(21) Appl. No.: 13/346,707

(22) Filed: Jan. 9, 2012

(51) Int. Cl. H04W 88/00; H04M 1/00

(52) U.S. Cl. 455/569.1; 379/430

(57) ABSTRACT

The headset of the invention includes a control unit, a switch unit, a connector, a speaker and a microphone. The connector is used for connecting an external device. The speaker is electrically connected to the control unit. The microphone is electrically connected to the control unit. The switch unit has a common contact electrically connecting the connector and two switch contacts electrically connected to the control unit for switching either the speaker or the microphone to electrically connect with the connector.

### BACKGROUND OF THE INVENTION

1. Technical Field

The invention relates to headsets, particularly to headsets which can connect various external devices.

2. Related Art

With progress of the electronic technologies, various electronic devices with different functions appear in the market, such as MP3 players, tablet computers and smart phones. In recent years, portable devices become extremely popular around the world. To listen to such portable devices, headsets have to be used.

Headsets can be personally used outdoors and indoors. Thus headsets are very convenient to be used without disturbing others.

However, audio signals from various electronic devices are different so that a proprietary headset which can receive audio signals from specific device is needed. A user who owns two or more electronic devices must frequently change headsets to match the device which is being used. This is very inconvenient and costs a lot for buying many headsets.

For example, the Xbox 360 manufactured by Microsoft requires a proprietary headset with a microphone. But the proprietary head set cannot be used for other audio players such as MP3 players. Those users who own Xbox 360 and an audio player must buy a headset and a headset for separate use.

### SUMMARY OF THE INVENTION

An object of the invention is to provide a headset with a switch function, which can match different types of audio signals from various electronic devices. Thus a user can use a single headset to receive audio signals from different devices.

To accomplish the above object, the headset of the invention includes a control unit, a switch unit, a connector, a speaker and a microphone. The connector is used for connecting an external device. The speaker is electrically connected to the control unit. The microphone is electrically connected to the control unit. The switch unit has a common contact electrically connecting the connector and two switch contacts electrically connected to the control unit for switching either the speaker or the microphone to electrically connect with the connector.

### BRIEF DESCRIPTION OF THE DRAWINGS

FIG. 1 is a block diagram of circuitry of the invention;

FIG. 2 is a perspective view of the invention;

FIG. 3 is an application of the invention in use with a game controller; and

FIG. 4 is an application of the invention in use with an audio player.

### DETAILED DESCRIPTION OF THE INVENTION

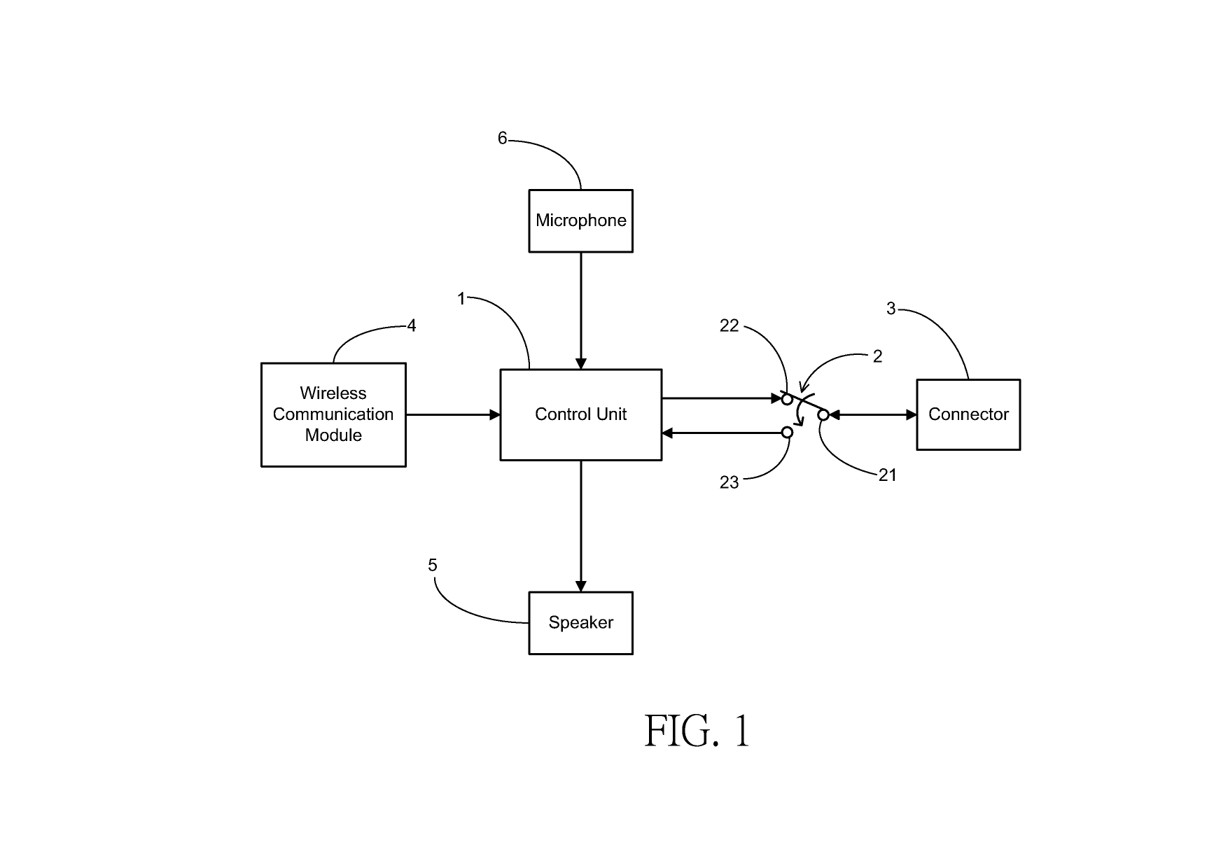

Please refer to FIG. 1. The headset of the invention includes a control unit 1, a switch unit 2, a connector 3, a speaker 5 and a microphone 6. The control unit 1 is a control center with signal processing. The connector 3 is used for connecting an external device such as a game controller or an audio player. Preferably, the connector 3 is a 3.5 mm phone jack. The speaker 5 is electrically connected to the control unit 1 for being driven by the control unit 1 to sound. The microphone 6 is electrically connected to the control unit 1 for picking up the sound from the user.

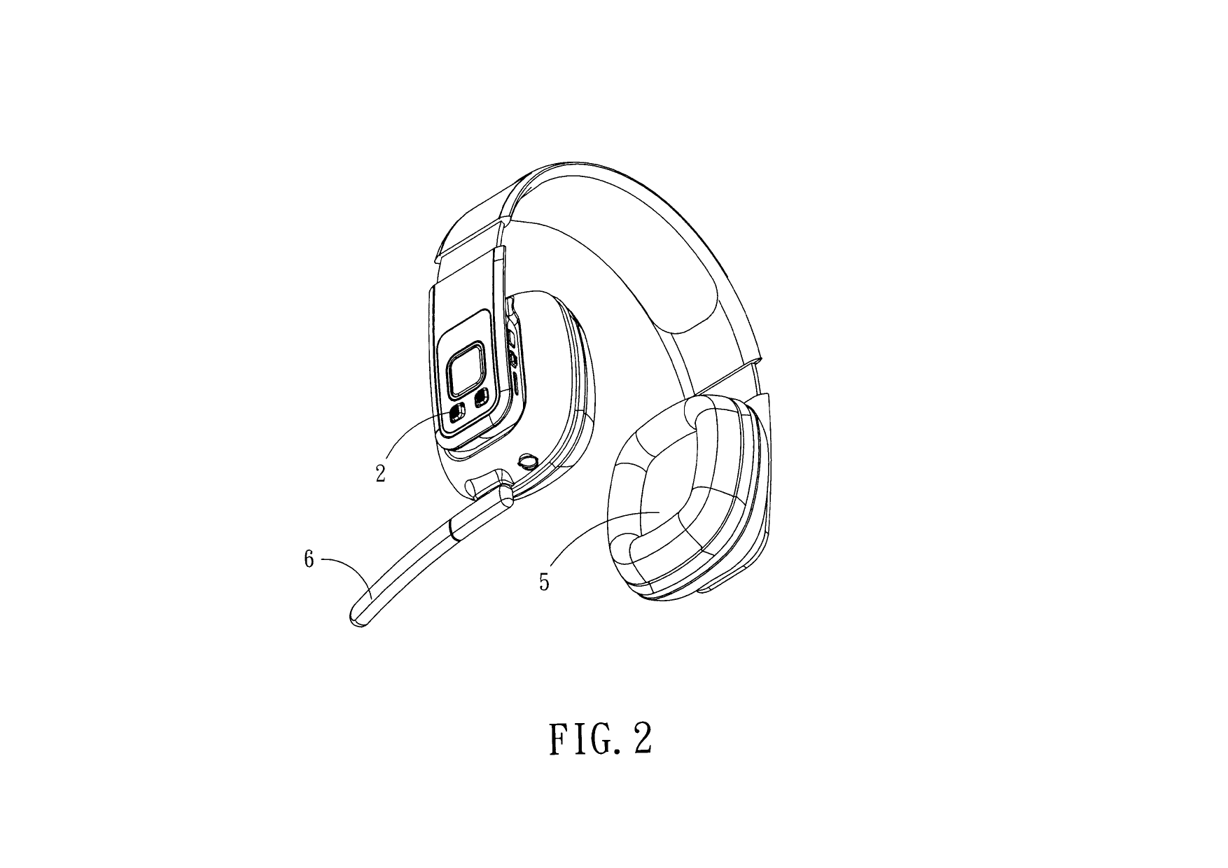

The switch unit 2 is provided with a common contact 21 electrically connected to the control unit 1 and two switch contacts 22, 23 electrically connected to the control unit 1 for switching either the speaker 5 or the microphone 6 to electrically connect with the connector 3. The switch unit 2 may be a mechanical switch which is directly operated by a user, such as a push button switch, or an electronic switch indirectly controlled by the control unit 1. Preferably, the switch unit 2 is arranged on an ear piece as shown in FIG. 2.

Additionally, a wireless communication module 4 is electrically connected to the control unit 1 for making a wireless connection with an external device such as an Xbox 360 to receive audio signals therefrom.

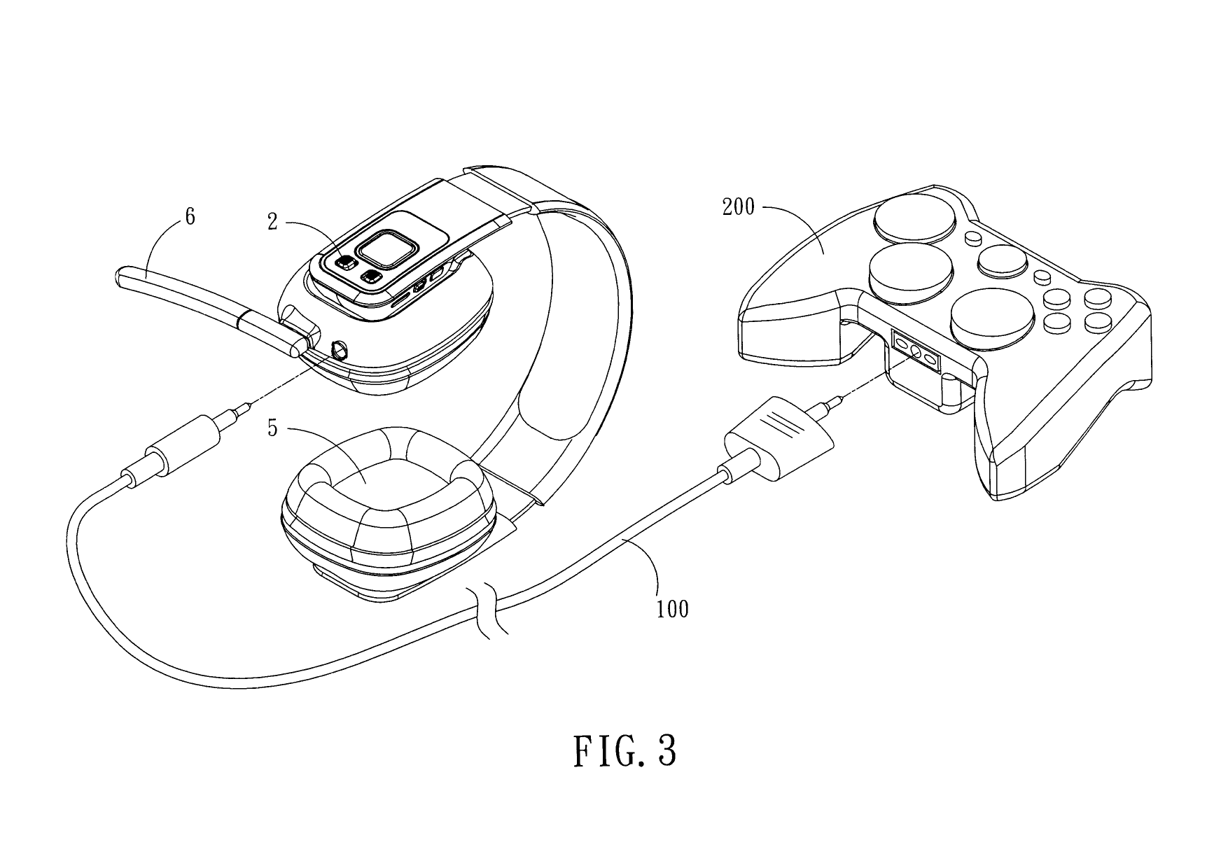

Please refer to FIG. 3. As shown, the headset electrically connects to a game controller 200 from the connector 3 through a wire 100, such as the Xbox 360 game console. At this time, the switch unit 2 is operated to the position connecting the first switch contact 22 with the common contact 21. That is to say, the connector 3 is connected to the microphone 6 to serve as a microphone outlet. The voice from the user wearing the headset can be transmitted from the microphone 6 to the game controller 200. On the other hand, because the Xbox uses a wireless communication technique to transmit audio signals, the wireless communication module 4 of the invention can correspondingly receive audio signals from the Xbox game console to be sounded by the speaker 5 through the control unit 1.

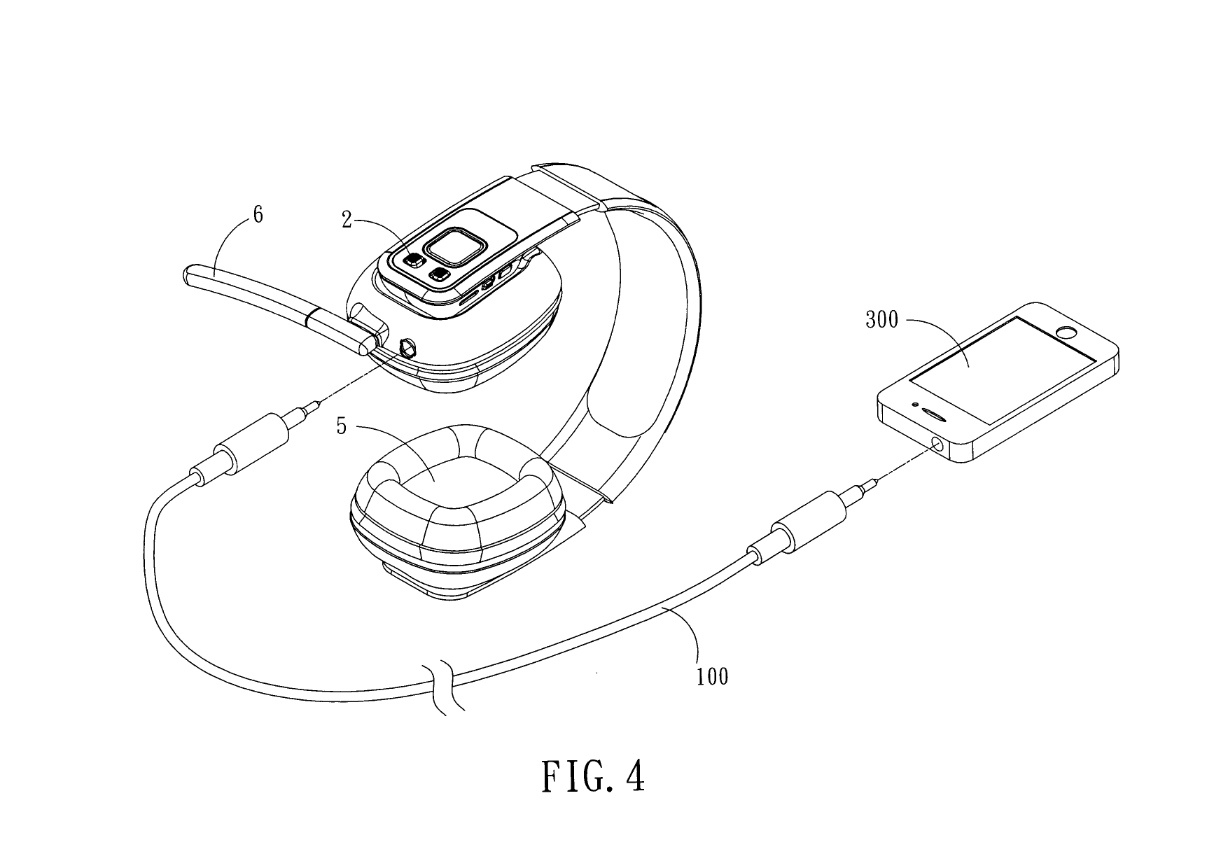

Please refer to FIG. 4. When a user wants to use the headset of the invention to serve as a normal headphone for listening to an audio player such as an MP3 player 300, all he/she has to do is operate the switch unit 2 to the position connecting the second switch contact 23 with the common contact 21 and connect the audio player 300 to the connector 3 by using a wire 100. That is to say, the connector 3 is connected to the speaker 5 to serve as a headphone inlet. At this time, the audio signals from the audio player 300 can be transmitted to the speaker 5. As a result, the headset functions as a normal headphone at present.

While the forgoing is directed to a preferred embodiment of the present invention, other and further embodiments of the invention may be devised without departing from the basic scope thereof. As such, the appropriate scope of the invention is to be determined according to the claims.

1. A headset with a mode switch function, comprising:
a control unit;
a connector for connecting an external device;
a speaker, electrically connected to the control unit;
a microphone, electrically connected to the control unit; and
a switch unit, being of a latching type, having a common contact electrically connecting the connector and two switch contacts electrically connected to the control unit for switching either the speaker or the microphone to electrically connect with the connector.

2. The headset of claim 1, wherein the switch unit is a mechanical switch.

3. The headset of claim 2, wherein the switch unit is a push button switch.

4. The headset of claim 1, wherein the switch unit is an electronic switch.

5. The headset of claim 1, wherein the switch unit is disposed on an ear piece.

6. The headset of claim 1, wherein the connector is a 3.5 mm phone jack.

7. The headset of claim 1, further comprising a wireless communication module electrically connected to the control unit.
